(19) United States
(12) Patent Application Publication
(10) Pub. No.: US 2016/0348628 A1
(43) Pub. Date: Dec. 1, 2016

(54) METHOD AND SYSTEM FOR DAMPING A CHECK VALVE

(71) Applicant: Caterpillar Inc., Peoria, IL (US)

(72) Inventors: SUNIL BEAN, PEORIA, IL (US); ALAN R. STOCKNER, METAMORA, IL (US); SANA MAHMOOD, PEORIA, IL (US)

(73) Assignee: CATERPILLAR INC., Peoria, IL (US)

(21) Appl. No.: 14/727,303

(22) Filed: Jun. 1, 2015

(51) Int. Cl. F02M 59/46; F16K 47/00; F16K 15/02

(52) U.S. Cl. CPC F02M 59/464; F16K 15/026; F16K 47/00

(57) ABSTRACT

The disclosure describes valve assemblies including a valve body movably disposed within a valve chamber and defining at least a portion of a cavity, wherein the cavity is used to regulate a position of the valve body between a first end and a second end of the valve chamber based on at least a pressure in the cavity.

### TECHNICAL FIELD

This patent disclosure relates generally to check valves and, more particularly, to a system and method for damping the check valves.

### BACKGROUND

Certain gaseous fueled powered engines require a cryogenic pump to transfer liquefied natural gas from an off-engine system to an on-engine fuel system. For a hydraulically driven multi-element cryogenic pump, it is highly desired to have a robust check valve (e.g., outlet discharge check valve) that can withstand sudden surges of flow and pressure waves created from a pumping element of the cryogenic pump. It is also desirable to minimize velocities during normal operation, to prevent hard impacts or spring damage.

A check valve that is allowed to have a high lift and minimal spring load is ideal to reduce pressure drop created by the valve during stroke. Also, valves of this type are less likely to chatter at low speed conditions in sinusoidal plunger motion pumps (such as cam driven pump). However, a typical valve of this nature tends to have high stroke and impact velocities that have to be balanced through design optimization to allow for a feasible design. High velocities not only affect the impact performance and wear of the valve, but also the life expectancy of the spring. Other damping alternatives are needed.

As an example, U.S. Pat. No. 4,257,452 purports to provide a poppet valve arranged so that it can be included in series in a flow line. The head of the poppet is mounted upstream from the seat. It is biased open so that fluid can flow through the line at any rate from zero up to some maximum flow velocity. Flow through the valve is arranged so that it impinges upon the valve head to move the valve head toward the seat. A dash pot cylinder is disposed upstream of the valve head to develop viscous friction which is used both to damp any tendency of the head to oscillate and to prevent valve operation in response to short term transients or perturbations. However, such a dash pot cylinder is not configured to manage large pressure impulses that can cause the valve head to accelerate and strike the valve seat on stroke or the dash pot cylinder on return with high velocities. These and other shortcomings of the prior art are addressed by the present disclosure.

### SUMMARY

In one aspect, the disclosure describes a valve assembly comprising: a housing defining a valve chamber, wherein the valve chamber comprises a first end and a second end opposite the first end; a valve inlet disposed adjacent the first end of the valve chamber and in fluid communication therewith, wherein the valve chamber is configured to receive a flow of fluid from the valve inlet; a valve outlet in fluid communication with the valve chamber to receive a flow of fluid from the valve chamber; a valve seat fixedly disposed at the first end of the valve chamber; a valve body movably disposed within the valve chamber, the valve body comprising a valve head and a base portion having one or more fluid passages formed therein or adjacent thereto; a retainer sealingly engaging the housing and defining a cavity between the base portion of the valve body and the retainer, wherein the one or more fluid passages are configured to provide fluid communication to the cavity to regulate a position of the valve body between the first end and the second end of the valve chamber based on at least a pressure difference between the valve inlet and the cavity; and a spring member disposed between the retainer and the valve body, wherein the spring member is configured to bias the valve body towards the first end of the valve chamber, and wherein the valve head of the valve body is configured to abut against the valve seat to prevent a flow of fluid between the valve inlet and the valve chamber.

In another aspect, the disclosure describes a valve assembly comprising: a housing defining a valve chamber, wherein the valve chamber comprises a first end and a second end opposite the first end; a valve inlet disposed adjacent the first end of the valve chamber and in fluid communication therewith, wherein the valve chamber is configured to receive a flow of fluid from the valve inlet; a valve outlet adjacent the second end of the valve chamber and in fluid communication therewith, wherein the valve outlet is configured to receive a flow of fluid from the valve chamber; a valve seat fixedly disposed at the first end of the valve chamber; a valve body movably disposed within the valve chamber, the valve body comprising a valve head and a base portion comprising one or more control orifices extending through the base portion and providing fluid communication between a portion of the valve chamber and the valve outlet to regulate a position of the valve body between the first end and the second end of the valve chamber based on at least a pressure difference between the valve inlet and the valve outlet; a retainer sealingly engaging the housing and defining a cavity between the base portion of the valve body and the retainer, wherein a clearance between the base portion and the housing is configured to provide fluid communication to the cavity to regulate a position of the valve body between the first end and the second end of the valve chamber based on at least a pressure difference between the valve inlet and the cavity; and a spring member disposed between the retainer and the valve body, wherein the spring member is configured to bias the valve body towards the first end of the valve chamber, and wherein the valve head of the valve body is configured to abut against the valve seat to prevent a flow of fluid between the valve inlet and the valve chamber.

In yet another aspect, the disclosure describes a valve assembly comprising: a housing defining a valve chamber, wherein the valve chamber comprises a first end and a second end opposite the first end; a valve inlet disposed adjacent the first end of the valve chamber and in fluid communication therewith, wherein the valve chamber is configured to receive a flow of fluid from the valve inlet; a valve outlet adjacent the second end of the valve chamber and in fluid communication therewith, wherein the valve outlet is configured to receive a flow of fluid from the valve chamber; a valve seat fixedly disposed at the first end of the valve chamber; a valve body movably disposed within the valve chamber, the valve body comprising a valve head and a base portion; a retainer sealingly engaging the housing and defining a cavity between the base portion of the valve body and the retainer, wherein a clearance between the base portion and the retainer is configured to provide fluid communication to the cavity to regulate a position of the valve body between the first end and the second end of the valve chamber based on at least a pressure difference between the valve inlet and the cavity; and a spring member disposed between the retainer and the valve body, wherein the spring member is configured to bias the valve body towards the first end of the valve chamber, and wherein the valve head of the valve body is configured to abut against the valve seat to prevent a flow of fluid between the valve inlet and the valve chamber.

### BRIEF DESCRIPTION OF THE DRAWINGS

FIG. 1 is a perspective view of a machine constructed in accordance with the aspects of the disclosure.

FIG. 2 is a schematic representation of a liquid natural gas (LNG) and diesel delivery system that may include the systems and methods in accordance with aspects of the present disclosure.

FIG. 3 is a cross-sectional view of a portion of a cryogenic pump including a valve assembly in accordance with aspects of the present disclosure, where the valve assembly is shown in a closed position.

FIG. 4 is a cross-sectional view of the valve assembly of FIG. 3, showing the valve assembly in an opened position.

FIG. 5 is a perspective view of a valve body of the valve assembly of FIGS. 3 and 4.

FIG. 6 is a cross-sectional view of a portion of a cryogenic pump including a valve assembly in accordance with aspects of the present disclosure, where the valve assembly is shown in a closed position.

FIG. 7 is a cross-sectional view of the valve assembly of FIG. 6, showing the valve assembly in an opened position.

FIG. 8 is a perspective view of a valve body of the valve assembly of FIGS. 6 and 7.

FIG. 9 is a cross-sectional view of a portion of a cryogenic pump including a valve assembly in accordance with aspects of the present disclosure, where the valve assembly is shown in a closed position.

FIG. 10 is a cross-sectional view of the valve assembly of FIG. 9, showing the valve assembly in an opened position.

FIG. 11 is a perspective view of a valve body of the valve assembly of FIGS. 9 and 10.

FIG. 12 is a graphical representation of displacement vs. time of a plunger of a cryogenic pump in accordance with aspects of this disclosure.

FIG. 13 is a graphical representation of valve body displacement vs. time of a conventional valve assembly and a valve assembly in accordance with aspects of this disclosure.

FIG. 14 is a graphical representation of valve body velocity vs. time of the conventional valve assembly and the valve assembly referenced in FIG. 13.

### DETAILED DESCRIPTION

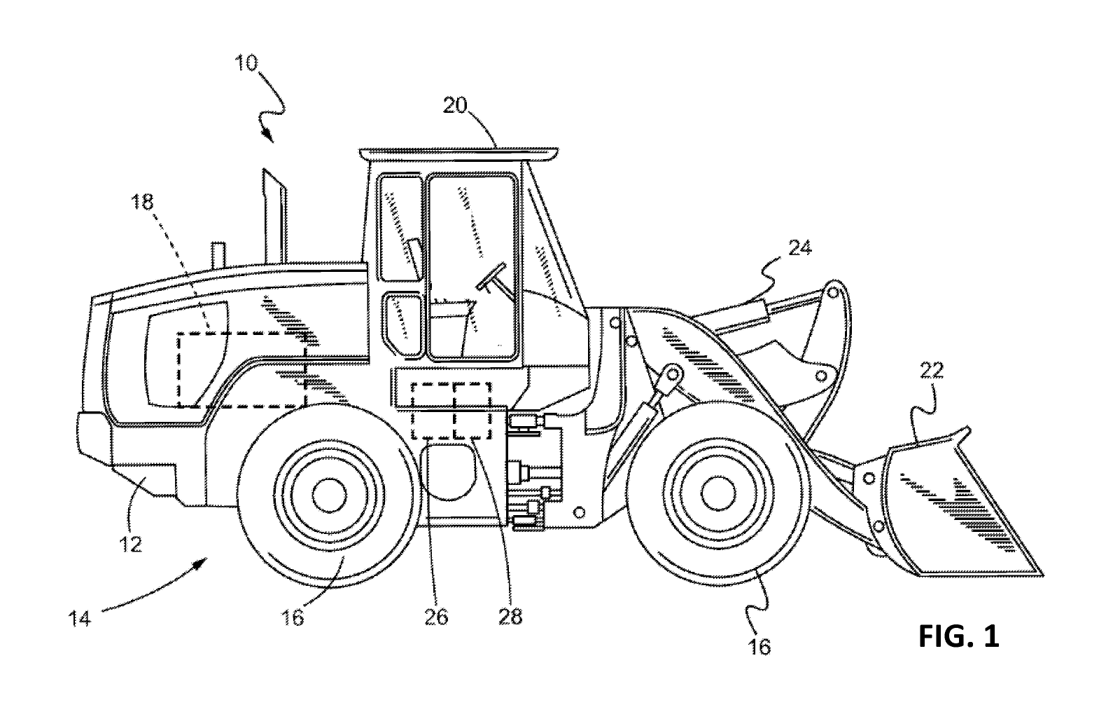

Now Referring now to the drawings, and with specific reference to FIG. 1, a machine 10 constructed in accordance with the teachings of the disclosure is shown in detail. Although the machine 10 depicted in FIG. 1 is that of a wheeled loader, it is to be understood that the teachings of the disclosure can find equal applicability in connection with many other moving machines such as, but not limited to, locomotives, track-type tractors, excavators, motor graders, pipe layers, dump trucks, articulated trucks, off-highway vehicles, on highway vehicles, machines in general including marine applications, generator sets, and the like.

As shown therein, the machine 10 may include a chassis 12 supported by a locomotion device 14. While the locomotion device 14 depicted in FIG. 1 is that of a plurality of wheels 16, any number of different other locomotion devices 14 can be used such as, but not limited to, continuous tracks. The chassis 12 may support an engine 18 as well as an operator cabin 20. The engine 18 can be provided in any number of different forms including internal combustion engines such as diesel engines and Otto cycle engines. In addition, the engine 18 may be adapted to run on diesel fuel or other fuels such as, but not limited to, liquefied natural gas (LNG). As used herein, LNG generally refers to liquefied natural gas such as, but not limited to, methane, but other types of natural gas are certainly possible as well.

Extending from the chassis 12, the machine 10 may include one or more work implements 22 adapted for movement relative to the chassis 12 by a plurality of hydraulic cylinders 24. While the work implement 22 is depicted as a bucket in FIG. 1, it is to be understood that any other number of other work implements including, but not limited to, tines, augers, brushes, forks, shovels and the like are certainly possible. As indicated above, the engine 18 may be adapted to operate in part using liquid natural gas as its fuel. Accordingly, a source of liquid natural gas such as a LNG tank 26 may be provided onboard the machine 10. A separate diesel fuel tank 28 may also be provided.

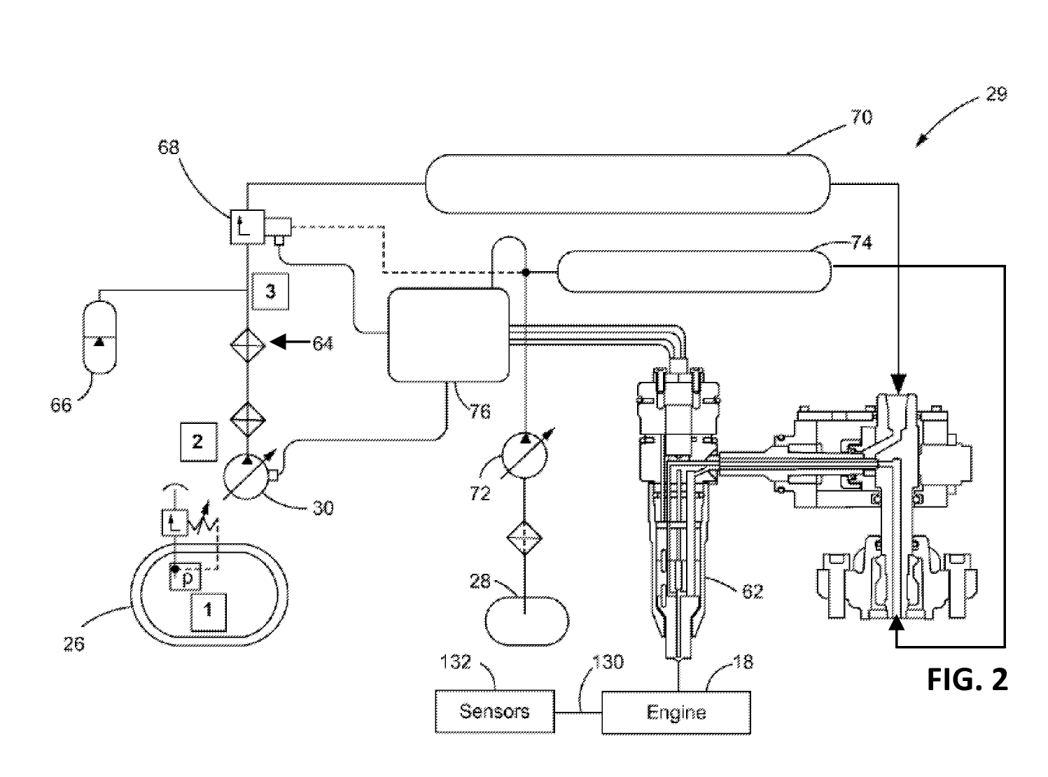

Referring now to FIG. 2, an overall fuel delivery system 29 for the machine 10 is depicted. As shown therein, a LNG cryogenic piston pump 30 may be in fluid communication with the LNG tank 26 for delivery of LNG to a fuel injector 62. The LNG tank 26 may be a cryogenic tank adapted to store the LNG at temperatures as low as −160° C., for example. The system 29 may further include a heat exchanger 64 to convert the LNG from LNG to CNG (compressed natural gas), and an accumulator 66 to store the added volume generated after the conversion and serve as a reservoir to ensure adequate pressure is always available. A pressure control valve 68 may be disposed downstream of the heat exchanger 64 prior to provision of the gas to a CNG rail or manifold 70. From the manifold 70, the gas is distributed to one of more of the aforementioned fuel injectors 62. To complete the structure forming the system 29, as the engine 18 may be powered by either LNG or diesel fuel, the system 29 further includes the diesel fuel tank 28, diesel fuel pump 72, and diesel fuel rail or manifold 74 for distribution of diesel fuel to the fuel injectors 62. An electronic control module (ECM) 76 is provided to control operation of the LNG pump 30, the valve 68 and the diesel fuel pump 72 as will now be described.

As noted above, the LNG pump 30 may be called upon to deliver a variable volume of LNG depending upon the speed at which the engine 18 is operating. For example, if the machine 10 is engaged in digging, loading, or in otherwise using its work implement, the engine 18 will be operating at a rated speed, whereas if the machine 10 is not performing useful work and is simply idling, the engine 18 will be working at a lower idle speed. Of course at the higher rated speed, the engine 18 will be requiring more fuel and at the lower idle speed, the engine will be requiring less fuel. This, in turn, requires that the variable displacement fuel pump 30 provide more or less fuel as dictated by the speed of the engine 18. Other engine parameters can certainly be used to dictate the amount of fuel being supplied by the fuel pump 30. In order to supply the LNG, the pump 30 may be provided as a piston pump and may include one or more valve assemblies such as outlet check valve assemblies, which will be discussed in further detail herein.

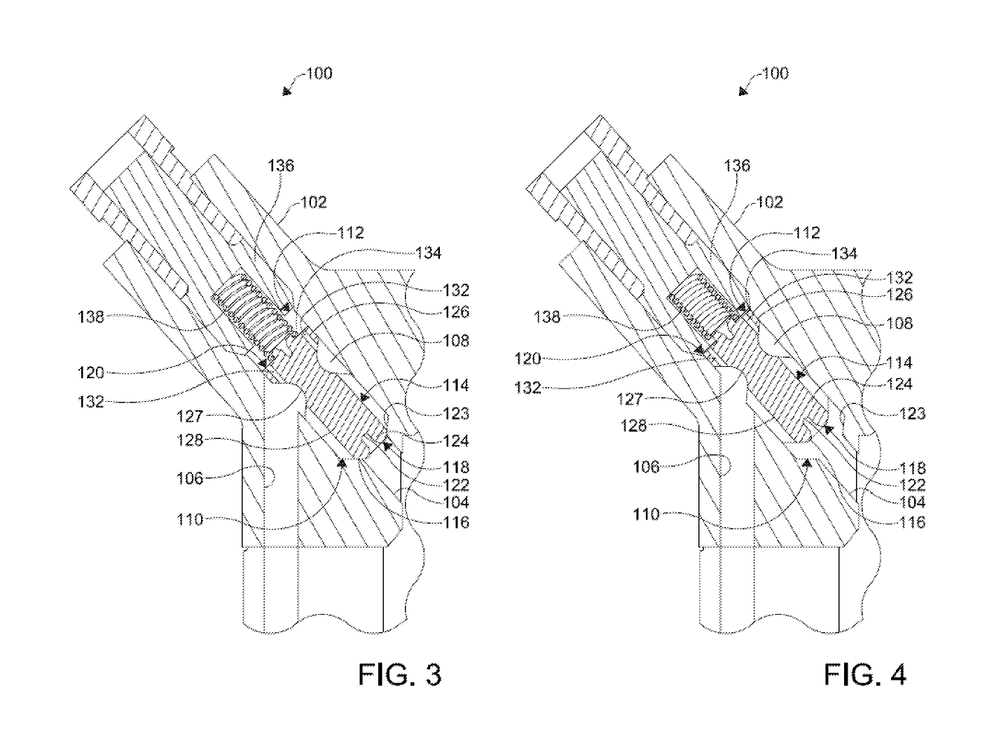

FIG. 3 illustrates a cross-sectional view of a valve assembly 100 according to aspects of the present disclosure, where the valve assembly 100 is shown in a closed position. The valve assembly 100 may include a housing 102 having a valve inlet 104 and a valve outlet 106 formed therein. As shown, the valve assembly 100 may include a valve chamber 108 defined by a portion of the housing 102. The valve chamber 108 may have a first end 110 and a second end 112 opposite the first end 110. The valve chamber 108 may be in fluid communication with the valve inlet 104 and the valve outlet 106. As shown in FIG. 3, the valve inlet 104 may be disposed adjacent the first end 110 of the valve chamber 108 and the valve outlet 106 may be disposed along a length of the valve chamber 108 between the first end 110 and the second end 112 of the valve chamber 108.

The valve body 114 may be moveably disposed in the valve chamber 108 and may slideably engage a portion of the housing 102. The valve body 114 may include a valve head 116 formed at a first end 118 of the valve body 114 opposite a second end 120 thereof. As shown, the valve head 116 may be oriented toward the first end 110 of the valve chamber 108. The valve head 116 may include a recessed portion 122 formed therein and configured to receive fluid under pressure in order to cause motion in the valve body 114. It is understood that the recessed portion 122 and the valve head 116 may have various shapes and sizes, for example. The valve head 116 may be configured to abut a valve seat 123 formed in a portion of the housing 102, for example, adjacent the valve inlet 104 at the first end 110 of the valve chamber 108. As shown in FIG. 3, the valve head 116 is in sealing engagement with the valve seat 123 such that the valve assembly 100 is in a closed or seated position. As shown in FIG. 4, the valve head 116 is spaced from the valve seat 123 such that the valve assembly 100 is in an opened position.

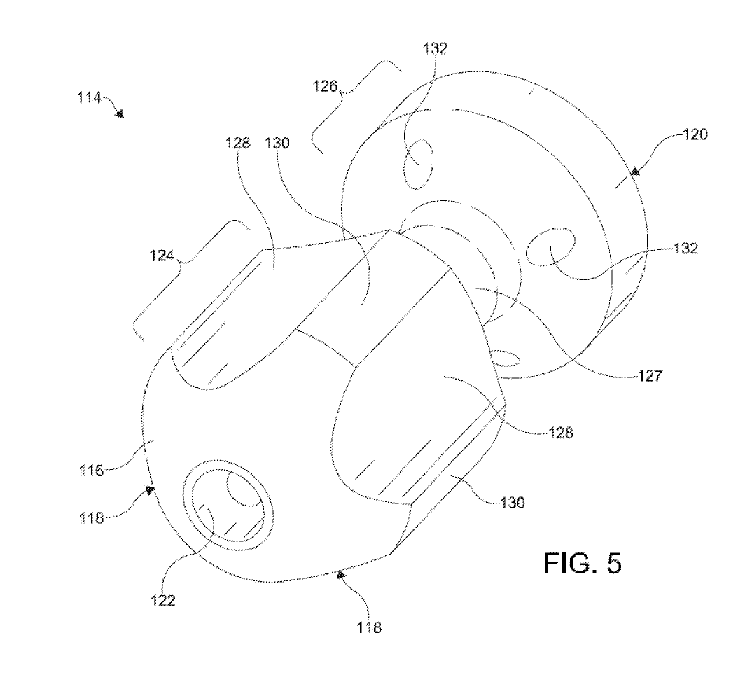

As more clearly shown in FIG. 5, the valve body 114 may include a fluted portion 124 and a base portion 126 spaced from the fluted portion 124. An indented portion 127 of the valve body 114 may be formed between the fluted portion 124 and the base portion 126 may include an outer diameter that is less than one or more of an outer diameter of the fluted portion 124 and the base portion 126. The fluted portion 124 may include one or more channels 128 and one or more protuberances 130 disposed adjacent the channels 128. As shown, four of the channels 128 are interposed with four of the protuberances 130. As an example, the protuberances 130 are sized to slideably engage a portion of the housing 102, while the channels 128 allow a controlled flow of fluid to pass the fluted portion 124 of the valve body 114. Other configurations of the fluted portion 124 may be used to provide a controlled fluid dynamics around the fluted portion 124 of the valve body 114.

The base portion 126 may include one or more fluid passages such as control orifices 132. The control orifices 132 may be of varying size and shape. Further, the control orifices 132 may include one or multiple flow restriction means configured to controllably manipulate flow dynamics of the system. The control orifices 132 may include holes, channels (e.g., flutes), clearances, and other arrangements to control flow dynamics through or around the base portion 126.

Returning to FIG. 3, the control orifices 132 of the valve body 114 may provide fluid communication between a portion of the valve chamber 108 and a cavity 134 (e.g., dead head cavity) defined at the second end 112 of the valve chamber 108. The control orifices 132 may be configured to regulate a position of the valve body 114 between the first end 110 and the second end 112 of the valve chamber 108 based on a pressure difference between the valve inlet 104 and the cavity 134.

A retainer 136 may be disposed adjacent the second end 112 of the valve chamber 108 and may sealingly engage a portion of the housing 102. A portion of the retainer 136 may define at least a portion of the cavity 134. As an example, the cavity 134 may be defined by the retainer 136, a portion of the housing 102, and the second end 120 of the valve body 114.

A spring member 138 may be disposed in the cavity 134 and may be configured to bias the valve body 114 toward the valve seat 123. As shown, the spring member 138 is disposed between the retainer 136 and the valve body 114. As an example, the spring member 138 may be or include a coil spring. Other biasing elements may be used.

As shown in FIG. 3, the valve head 116 is in sealing engagement with the valve seat 123 such that the valve assembly 100 is in a closed or seated position, thereby preventing a flow of the liquid fuel between the valve inlet 104 and the valve chamber 108. As pressurized fluid flows through the valve inlet 104, such as during actuation of a plunger or piston of an associated cryogenic pump (e.g., pump 30 (FIG. 2)), a force is exerted on the valve head 116 in opposition to the bias of the spring member 138. As pressure builds at the valve inlet 104, the forces on the valve head 116 exceed the bias force of the spring member 138 and the valve body 114 moves away from the valve seat 123 and compresses the spring member 138. Additionally, as the valve body 114 moves away from the valve seat 123, the fluid in the cavity 134 is compressed, thereby providing an additional biasing force in opposition of the movement of the valve body 114 toward the cavity 134. The fluid pressure in the cavity 134 mitigates pressure impulses that would normally cause the valve body 114 to compress the spring member 138 and even contact the retainer 136 at high velocities. The dimensions of the control orifices 132, a cross-sectional area of the valve body 114, a surface area and/or shape of the fluted portion 124, and the stiffness of the spring member 138 may be configured so as to control a movement and/or position of the valve body 114 under various pressure conditions.

As shown in FIG. 4, the valve head 116 is spaced from the valve seat 123 such that the valve assembly 100 is in an opened position. As such, fluid may flow from the valve inlet 104 pass the fluted portion 124 of the valve body 114 and through the valve outlet 106. When pressure is reduced at the valve inlet 104, the spring member 138 biases the valve body 114 toward the valve seat 123. However, the bias force of the spring member 138 is controlled by a pressure change in the cavity 134. For example, as the valve body 114 moves toward the valve seat 123, a pressure is reduced in the cavity 134 causing an opposing force to the bias of the spring member 138. The control orifices 132 allow fluid to back fill the cavity 134 in a controlled manner and such control orifices 132 may be configured along with the spring member 138 to provide a controlled motion of the valve body 114.

As an illustrative example, as the linear motion of the valve body 114 changes the volume of the cavity 134, a sudden motion of the valve body 114 is impeded by the flow dynamics of the cavity 134. Therefore, the cavity 134 decreases the maximum impact velocity of both the stroke and return motions of the valve body 114. As such, wear of the valve assembly 100 may be reduced and the life expectancy of the spring member 138 may be increased.

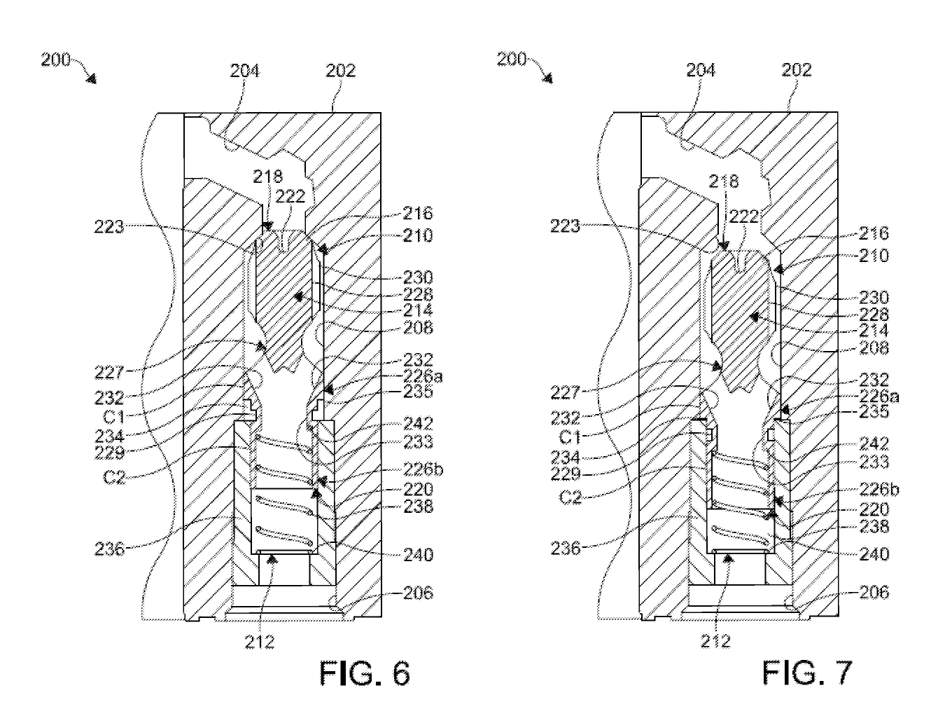

FIG. 6 illustrates a cross-sectional view of a valve assembly 200 according to aspects of the present disclosure, where the valve assembly 200 is shown in a closed position. The valve assembly 200 may include a housing 202 having a valve inlet 204 and a valve outlet 206 formed therein. As shown, the valve assembly 200 may include a valve chamber 208 defined by a portion of the housing 202. The valve chamber 208 may have a first end 210 and a second end 212 opposite the first end 210. The valve chamber 208 may be in fluid communication with the valve inlet 204 and the valve outlet 206. As shown in FIG. 6, the valve inlet 204 may be disposed adjacent the first end 210 of the valve chamber 208 and the valve outlet 206 may be disposed adjacent the second end 212 of the valve chamber 208.

The valve body 214 may be moveably disposed in the valve chamber 208 and may slideably engage a portion of the housing 202. The valve body 214 may include a valve head 216 formed at a first end 218 of the valve body 214 opposite a second end 220 thereof. As shown, the valve head 216 may be oriented toward the first end 210 of the valve chamber 208. The valve head 216 may include a recessed portion 222 formed therein and configured to receive fluid under pressure in order to cause motion in the valve body 214. It is understood that the recessed portion 222 and the valve head 216 may have various shapes and sizes, for example. The valve head 216 may be configured to abut a valve seat 223 formed in a portion of the housing 202, for example, adjacent the valve inlet 204 at the first end 210 of the valve chamber 208. As shown in FIG. 6, the valve head 216 is in sealing engagement with the valve seat 223 such that the valve assembly 200 is in a closed or seated position. As shown in FIG. 7, the valve head 216 is spaced from the valve seat 223 such that the valve assembly 200 is in an opened position.

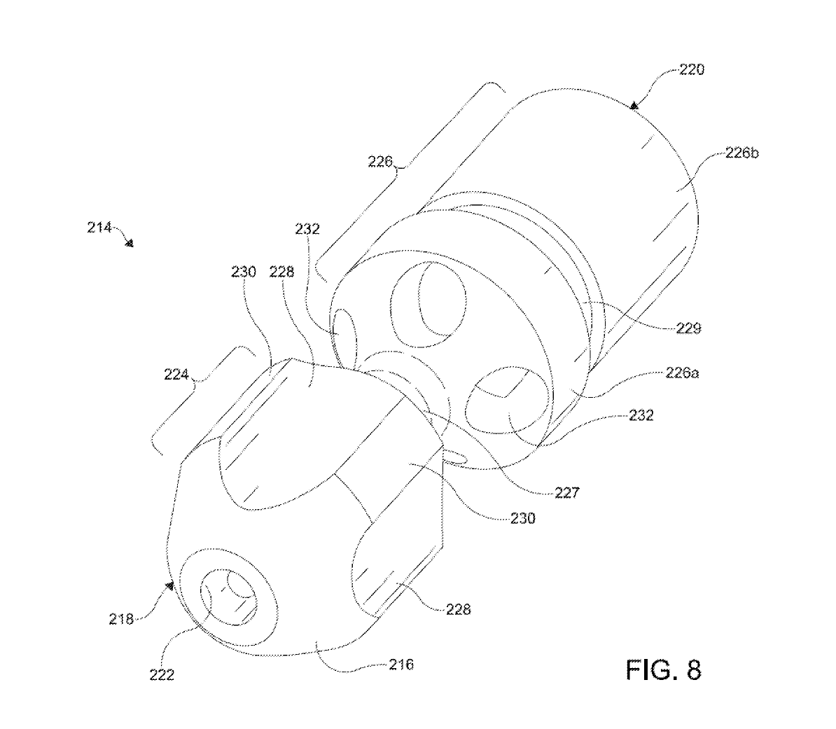

As more clearly shown in FIG. 8, the valve body 214 may include a fluted portion 224 and a base portion 226 spaced from the fluted portion 224. An indented portion 227 of the valve body 214 may be formed between the fluted portion 224 and the base portion 226 may include an outer diameter that is less than one or more of an outer diameter of the fluted portion 224 and the base portion 226. The fluted portion 224 may include one or more channels 228 and one or more protuberances 230 disposed adjacent the channels 228. As shown, four of the channels 228 are interposed with four of the protuberances 230. As an example, the protuberances 230 may be sized to slideably engage a portion of the housing 202 or may be spaced from the housing 202, as shown in FIGS. 6 and 7. Other configurations of the fluted portion 224 may be used to provide a controlled fluid dynamics around the fluted portion 224 of the valve body 214.

In reference to FIG. 8, the base portion 226 may include one or more control orifices 232 extending therethrough. The control orifices 232 may be of varying size and shape. Further, the control orifices 232 may include one or multiple flow restriction means configured to controllably manipulate flow dynamics of the system. The control orifices 232 may include holes, channels (e.g., flutes), and other arrangement to control flow dynamics through or around the base portion 226.

The base portion 226 may further include a guide portion 226a and a control portion 226b. As an example, the guide portion 226a may have an outer diameter that is sized to provide a fluid passage such as a guide clearance C1 (e.g., about 30 micron) between the guide portion 226a and the housing 102. As a further example, the control portion 226b may have an outer diameter that is smaller than the outer diameter of the guide portion 226a. Other diameters and configurations may be used. In certain aspects, an annular channel 229 may be formed about at least a portion of an outer periphery of the control portion 226b to provide additional volume between the base portion 226 and a portion of the housing 202 and/or a retainer 236 (FIG. 6).

Returning to FIG. 6, a plurality of the control orifices 232 are in fluid communication with an internal channel 233 formed in the base portion 226 of the valve body 214 and in fluid communication with the valve outlet 106. The control orifices 232 of the valve body 214 may provide fluid communication between a portion of valve chamber 208 and the valve outlet 206. The control orifices 232 may be configured to regulate a position of the valve body 214 between the first end 210 and a second end 212 of the valve chamber 208 based on a pressure difference between the valve inlet 204 and the valve outlet 206.

The retainer 236 may be disposed adjacent the second end 212 of the valve chamber 208 and may sealingly engage a portion of the housing 202. A portion of the retainer 236 may be configured to receive at least a portion of the control portion 226b of the valve body 214. As an example, an outer diameter of the control portion 226b may be sized to provide a fluid passage such as a control clearance C2 (e.g., about 100 microns) between the control portion 226b and the retainer 236.

A cavity 234 may be defined by the retainer 236, a portion of the housing 102, a shoulder 235 of the guide portion 226a, and/or (where included) a volume defined by the annular channel 229. As an example, the guide clearance between the guide portion 226a and the housing 202 may control a flow of fluid between the valve chamber 208 and the cavity 234. The cavity 234 may be fluidly disposed downstream from the valve inlet 204 and upstream from the valve outlet 206. A volume of the cavity 234, while the valve body 214 is abutting the valve seat 223, may be configured by adjusting one or more of the a relative position and/or size of the retainer 236, the housing 102, the shoulder 235 of the guide portion 226a, and (where included) the annular channel 229.

A spring member 238 may be disposed in the retainer 236 and/or a portion of the internal channel 233 and may be configured to bias the valve body 214 toward the valve seat 223. As shown, the spring member 238 is disposed between a shoulder 240 defined in the retainer 136 and a shoulder 242 defined in the internal channel 233 of the valve body 214. As an example, the spring member 238 may be or include a coil spring. Other biasing elements may be used.

As shown in FIG. 6, the valve head 216 is in sealing engagement with the valve seat 223 such that the valve assembly 200 is in a closed or seated position, thereby preventing a flow of the liquid fuel between the valve inlet 204 and the valve chamber 208. As pressurized fluid flows through the valve inlet 204, such as during actuation of a plunger or piston of an associated cryogenic pump (e.g., pump 30 (FIG. 2)), a force is exerted on the valve head 216 in opposition to the bias of the spring member 238. As pressure builds at the valve inlet 204, the forces on the valve head 216 exceed the bias force of the spring member 238 and the valve body 214 moves away from the valve seat 223 and compresses the spring member 238. Additionally, as the valve body 214 moves away from the valve seat 223, the fluid in the cavity 234 is compressed, thereby providing an additional biasing force in opposition of the movement of the valve body 214 toward the cavity 234. The fluid pressure in the cavity 234 mitigates pressure impulses that would normally cause the valve body 214 to compress the spring member 238 and even contact the retainer 236 at high velocities. The dimensions of the control orifices 232, a cross-sectional area of the valve body 214, a surface area and/or shape of the fluted portion 224, and the stiffness of the spring member 238 may be configured so as to control a movement and/or position of the valve body 214 under various pressure conditions.

As shown in FIG. 7, the valve head 216 is spaced from the valve seat 223 such that the valve assembly 200 is in an opened position. As such, fluid may flow from the valve inlet 204 pass the fluted portion 224 of the valve body 214 and through control orifices 232 and internal channel 233 toward the valve outlet 106. A controlled amount of fluid may move through the guide clearance C1 and into the cavity 234. Additionally, fluid may move from the cavity 234 through the control clearance C2 toward the valve outlet 206.

When pressure is reduced at the valve inlet 204, the spring member 238 biases the valve body 214 toward the valve seat 223. However, the bias force of the spring member 238 is controlled by a pressure change in the cavity 234. For example, as the valve body 214 moves toward the valve seat 223, a pressure is reduced in the cavity 234 causing an opposing force to the bias of the spring member 238. The guide clearance C1 and the control clearance C2 allow fluid to move into the cavity 234 in a controlled manner and the same may be configured (along with the spring member 238) to provide a controlled motion of the valve body 214.

As an illustrative example, as the linear motion of the valve body 214 changes the volume of the cavity 234, a sudden motion of the valve body 214 is impeded by the flow dynamics of the cavity 234. Therefore, the cavity 234 decreases the maximum impact velocity of both the stroke and return motions of the valve body 214. As such, wear of the valve assembly 200 may be reduced and the life expectancy of the spring member 238 may be increased.

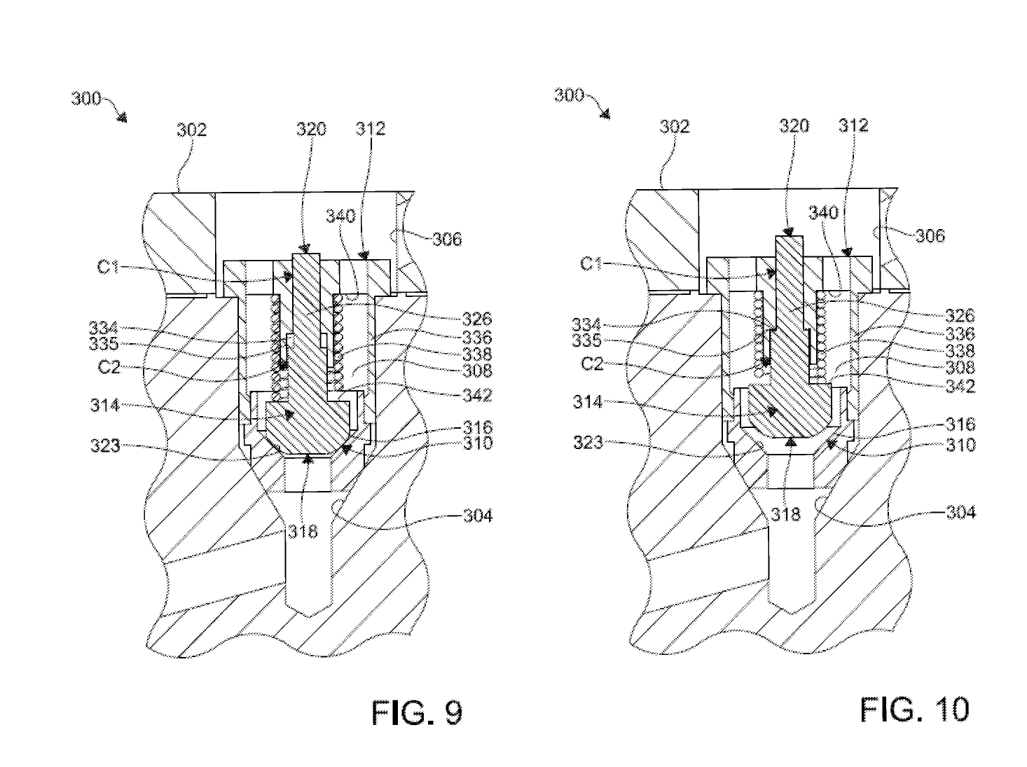

FIG. 9 illustrates a cross-sectional view of a valve assembly 300 according to aspects of the present disclosure, where the valve assembly 300 is shown in a closed position. The valve assembly 300 may include a housing 302 having a valve inlet 304 and a valve outlet 306 formed therein. As shown, the valve assembly 300 may include a valve chamber 308 defined by a portion of the housing 302 and/or a portion of a retainer 336. The valve chamber 308 may have a first end 310 and a second end 312 opposite the first end 310. The valve chamber 308 may be in fluid communication with the valve inlet 304 and the valve outlet 306. As shown in FIG. 9, the valve inlet 304 may be disposed adjacent the first end 310 of the valve chamber 308 and the valve outlet 306 may be disposed adjacent the second end 312 of the valve chamber 308.

The valve body 314 may be moveably disposed in the valve chamber 308. The valve body 314 may include a valve head 316 formed at a first end 318 of the valve body 314 opposite a second end 320 thereof. As shown, the valve head 316 may be oriented toward the first end 310 of the valve chamber 308. The valve head 316 may be configured to abut a valve seat 323 formed in a portion of the housing 302, for example, adjacent the valve inlet 304 at the first end 310 of the valve chamber 308. As shown in FIG. 9, the valve head 316 is in sealing engagement with the valve seat 323 such that the valve assembly 300 is in a closed or seated position. As shown in FIG. 10, the valve head 316 is spaced from the valve seat 323 such that the valve assembly 300 is in an opened position.

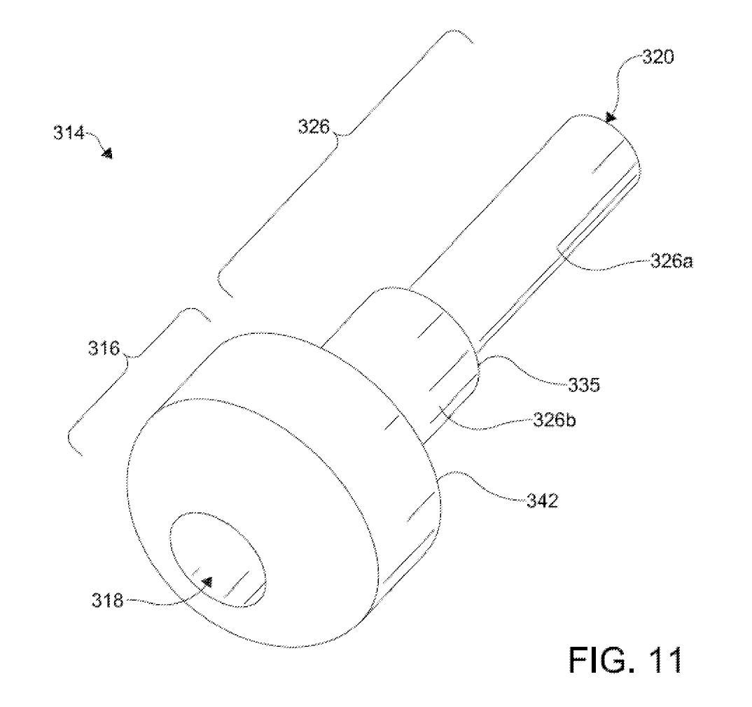

As more clearly shown in FIG. 11, the valve body 314 may include a base portion 326 disposed adjacent the valve head 316. The base portion 326 may further include a guide portion 326a and a control portion 326b. As an example, the guide portion 326a may have an outer diameter that is sized to provide a fluid passage such as a guide clearance C1 (e.g., about 30 micron) between the guide portion 326a and the retainer 336. As another example, the control portion 326b may have an outer diameter that is sized to provide fluid passage such as a control clearance C2 (e.g., about 100 micron) between the control portion 326b and the retainer 336. As a further example, the control portion 326b may have an outer diameter that is larger than the outer diameter of the guide portion 326a. Other diameters and configurations may be used.

The retainer 336 may be disposed adjacent the second end 312 of the valve chamber 308 and may sealingly engage a portion of the housing 302. A portion of the retainer 336 may be configured to receive at least a portion of the guide portion 326a and/or the control portion 326b of the valve body 314.

A cavity 334 may be defined by the retainer 336 and a shoulder 335 of the control portion 226b. As an example, the control clearance C2 between the control portion 326b and the retainer 336 may control a flow of fluid between the valve chamber 308 and the cavity 334. As a further example, the guide clearance C1 between the guide portion 326a and the retainer 336 may control a flow of fluid between the cavity 334 and the valve outlet 306. The cavity 334 may be fluidly disposed downstream from the valve inlet 304 and upstream from the valve outlet 306. A volume of the cavity 334, while the valve body 314 is abutting the valve seat 323, may be configured by adjusting one or more of the a relative position and/or size of the retainer 336 and the shoulder 335 of the control portion 326b.

A spring member 338 may be disposed in the retainer 336 and/or a portion of the valve chamber 308 and may be configured to bias the valve body 314 toward the valve seat 323. As shown, the spring member 338 is disposed between a shoulder 340 defined in the retainer 336 and a shoulder 342 defined by the valve head 316 of the valve body 314. As an example, the spring member 338 may be or include a coil spring. Other biasing elements may be used.

As shown in FIG. 9, the valve head 316 is in sealing engagement with the valve seat 323 such that the valve assembly 300 is in a closed or seated position, thereby preventing a flow of the liquid fuel between the valve inlet 304 and the valve chamber 308. As pressurized fluid flows through the valve inlet 304, such as during actuation of a plunger or piston of an associated cryogenic pump (e.g., pump 30 (FIG. 2)), a force is exerted on the valve head 316 in opposition to the bias of the spring member 338. As pressure builds at the valve inlet 304, the forces on the valve head 316 exceed the bias force of the spring member 338 and the valve body 314 moves away from the valve seat 323 and compresses the spring member 338. Additionally, as the valve body 314 moves away from the valve seat 323, the fluid in the cavity 334 is compressed, thereby providing an additional biasing force in opposition of the movement of the valve body 314 toward the cavity 334. The fluid pressure in the cavity 334 mitigates pressure impulses that would normally cause the valve body 314 to compress the spring member 338 and even contact the retainer 336 at high velocities.

As shown in FIG. 10, the valve head 316 is spaced from the valve seat 323 such that the valve assembly 300 is in an opened position. As such, fluid may flow from the valve inlet 304 around the valve head 316 of the valve body 214 and through the valve chamber 308 toward the valve outlet 106. A controlled amount of fluid may move through the control clearance C2 and into the cavity 334. Additionally, fluid may move from the cavity 334 through the guide clearance C1 toward the valve outlet 306.

When pressure is reduced at the valve inlet 304, the spring member 338 biases the valve body 314 toward the valve seat 323. However, the bias force of the spring member 338 is controlled by a pressure change in the cavity 334. For example, as the valve body 314 moves toward the valve seat 323, a pressure is reduced in the cavity 334 causing an opposing force to the bias of the spring member 338. The guide clearance C1 and the control clearance C2 allow fluid to move into the cavity 334 in a controlled manner and the same may be configured (along with the spring member 338) to provide a controlled motion of the valve body 314.

As an illustrative example, as the linear motion of the valve body 314 changes the volume of the cavity 334, a sudden motion of the valve body 314 is impeded by the flow dynamics of the cavity 334. Therefore, the cavity 334 decreases the maximum impact velocity of both the stroke and return motions of the valve body 314. As such, wear of the valve assembly 300 may be reduced and the life expectancy of the spring member 338 may be increased.

### INDUSTRIAL APPLICABILITY

The present disclosure is applicable to fluid systems configured with a valve assembly such as a check valve assembly. As an example, a cryogenic pump system may include an outlet check valve that may be configured in accordance with this disclosure. As noted above and with reference to FIGS. 1 and 2, the LNG pump 30 may be called upon to deliver a variable volume of LNG depending upon the speed at which the engine 18 is operating. For example, if the machine 10 is engaged in digging, loading, or in otherwise using its work implement, the engine 18 will be operating at a rated speed, whereas if the machine 10 is not performing useful work and is simply idling, the engine 18 will be working at a lower idle speed. In order to supply the LNG, the pump 30 may be provided as a piston pump and may include one or more valve assemblies such as outlet check valve assemblies. As the pump 30 is actuated, various internal pressures may cause the outlet check valve assemblies to actuate to release pressure.

In certain instances, the pressure impulse at an inlet of the check valve is so large that a valve body of the check valve is caused to move from a valve seat at high acceleration and contacts a retainer or housing element at high velocities. The valve body can bounce from the impact with the retainer causing undesirable pressure fluctuation and chatter.

Referring to FIGS. 3-11, the valve assemblies 100, 200, 300 of this disclosure provide additional control of the valve body motion by leveraging fluid cavities and clearances. The addition of these features makes feasible a larger envelope of designs that are intended to minimize pressure drop, typically those check valve designs that are higher lift and “softer” spring. This also allows for the design of check valves that are less likely to chatter in a sinusoidal plunger motion pump due to the ability to reduce the spring rate and preload.

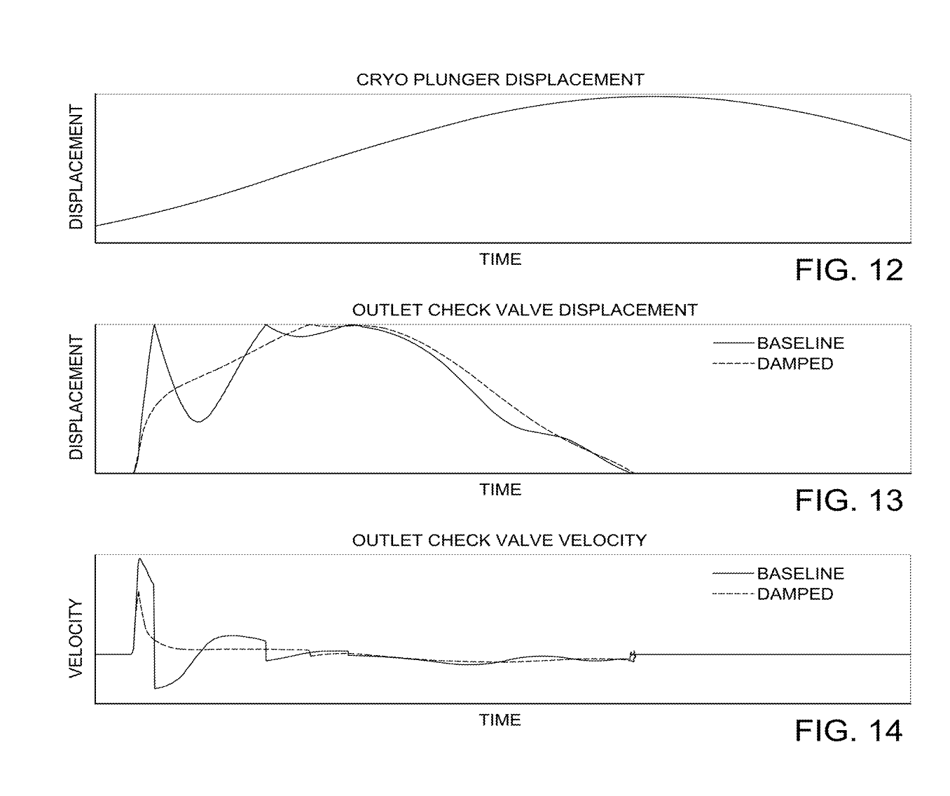

As an illustrative example, FIGS. 12, 13, and 14 illustrate exemplary graphs of the function of the valve assembly 100 of FIGS. 3 and 4. FIG. 12 illustrates displacement of an example plunger of a cryogenic pump vs. time. FIG. 13 illustrates a comparison between a conventional check valve displacement and the displacement of the valve assembly 100 over time and in response to the displacement of the plunger shown in FIG. 12. FIG. 14 illustrates a comparison between a conventional check valve velocity and the velocity of the valve assembly 100 over time and in response to the displacement of the plunger shown in FIG. 12. As illustrated in FIGS. 13 and 14, the valve assembly 100 provides a controlled motion which reduces the maximum velocity of the valve body 114 and slows the overall displacement of the valve body 114 during an opening event (e.g., stroke) and a closing event (e.g., return).

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein may be performed in any suitable order unless otherwise indicated herein or otherwise clearly contradicted by context.

We claim:

1. A valve assembly comprising:
a housing defining a valve chamber, wherein the valve chamber comprises a first end and a second end opposite the first end;
a valve inlet disposed adjacent the first end of the valve chamber and in fluid communication therewith, wherein the valve chamber is configured to receive a flow of fluid from the valve inlet;
a valve outlet in fluid communication with the valve chamber to receive a flow of fluid from the valve chamber;
a valve seat fixedly disposed at the first end of the valve chamber;
a valve body movably disposed within the valve chamber, the valve body comprising a valve head and a base portion having one or more fluid passages formed therein or adjacent thereto;
a retainer sealingly engaging the housing and defining a cavity between the base portion of the valve body and the retainer, wherein the one or more fluid passages are configured to provide fluid communication to the cavity to regulate a position of the valve body between the first end and the second end of the valve chamber based on at least a pressure difference between the valve inlet and the cavity; and
a spring member disposed between the retainer and the valve body, wherein the spring member is configured to bias the valve body towards the first end of the valve chamber, and wherein the valve head of the valve body is configured to abut against the valve seat to prevent a flow of fluid between the valve inlet and the valve chamber.

2. The valve assembly of claim 1, wherein the valve head further comprises a fluted portion having at least one fluid channel formed therein.

3. The valve assembly of claim 1, wherein the valve outlet is disposed along a length of the valve chamber between the first end of the valve chamber and a second end of the valve chamber.

4. The valve assembly of claim 1, wherein the valve body further comprises an indented portion disposed between the valve head and the base portion.

5. The valve assembly of claim 1, wherein the one or more fluid passages comprise an orifice, a channel, or a clearance, or a combination thereof.

6. The valve assembly of claim 1, wherein the valve inlet is in fluid communication with an outlet of a cryogenic pump.

7. A valve assembly comprising:
a housing defining a valve chamber, wherein the valve chamber comprises a first end and a second end opposite the first end;
a valve inlet disposed adjacent the first end of the valve chamber and in fluid communication therewith, wherein the valve chamber is configured to receive a flow of fluid from the valve inlet;
a valve outlet adjacent the second end of the valve chamber and in fluid communication therewith, wherein the valve outlet is configured to receive a flow of fluid from the valve chamber;
a valve seat fixedly disposed at the first end of the valve chamber;
a valve body movably disposed within the valve chamber, the valve body comprising a valve head and a base portion comprising one or more control orifices extending through the base portion and providing fluid communication between a portion of the valve chamber and the valve outlet to regulate a position of the valve body between the first end and the second end of the valve chamber based on at least a pressure difference between the valve inlet and the valve outlet;
a retainer sealingly engaging the housing and defining a cavity between the base portion of the valve body and the retainer, wherein a clearance between the base portion and the housing is configured to provide fluid communication to the cavity to regulate a position of the valve body between the first end and the second end of the valve chamber based on at least a pressure difference between the valve inlet and the cavity; and
a spring member disposed between the retainer and the valve body, wherein the spring member is configured to bias the valve body towards the first end of the valve chamber, and wherein the valve head of the valve body is configured to abut against the valve seat to prevent a flow of fluid between the valve inlet and the valve chamber.

8. The valve assembly of claim 7, wherein the valve head further comprises a fluted portion having at least one fluid channel formed therein.

9. The valve assembly of claim 7, wherein the valve body further comprises an indented portion disposed between the valve head and the base portion.

10. The valve assembly of claim 7, wherein the valve inlet is in fluid communication with an outlet of a cryogenic pump.

11. The valve assembly of claim 7, wherein the base portion further comprises a guide portion defining a guide clearance between the housing and the guide portion, and wherein the guide clearance comprises the clearance that provides fluid communication to the cavity to regulate a position of the valve body between the first end and the second end of the valve chamber based on at least a pressure difference between the valve inlet and the cavity.

12. The valve assembly of claim 11, wherein a shoulder defined by the guide portion defines at least a portion of the cavity.

13. The valve assembly of claim 7, wherein the base portion further comprises a control portion disposed adjacent the retainer and defining a control clearance between the control portion and the retainer, and wherein the control clearance provides fluid communication between the cavity and the valve outlet to regulate a position of the valve body between the first end and the second end of the valve chamber based on at least a pressure difference between the cavity and the valve outlet.

14. A valve assembly comprising:
a housing defining a valve chamber, wherein the valve chamber comprises a first end and a second end opposite the first end;
a valve inlet disposed adjacent the first end of the valve chamber and in fluid communication therewith, wherein the valve chamber is configured to receive a flow of fluid from the valve inlet;
a valve outlet adjacent the second end of the valve chamber and in fluid communication therewith, wherein the valve outlet is configured to receive a flow of fluid from the valve chamber;
a valve seat fixedly disposed at the first end of the valve chamber;
a valve body movably disposed within the valve chamber, the valve body comprising a valve head and a base portion;
a retainer sealingly engaging the housing and defining a cavity between the base portion of the valve body and the retainer, wherein a clearance between the base portion and the retainer is configured to provide fluid communication to the cavity to regulate a position of the valve body between the first end and the second end of the valve chamber based on at least a pressure difference between the valve inlet and the cavity; and
a spring member disposed between the retainer and the valve body, wherein the spring member is configured to bias the valve body towards the first end of the valve chamber, and wherein the valve head of the valve body is configured to abut against the valve seat to prevent a flow of fluid between the valve inlet and the valve chamber.

15. The valve assembly of claim 14, wherein the valve head further comprises a fluted portion having at least one fluid channel formed therein.

16. The valve assembly of claim 14, wherein the valve inlet is in fluid communication with an outlet of a cryogenic pump.

17. The valve assembly of claim 14, wherein the base portion further comprises a guide portion disposed adjacent the retainer and defining a guide clearance between the retainer and the guide portion, and wherein the guide clearance provides fluid communication between the cavity and the valve outlet to regulate a position of the valve body between the first end and the second end of the valve chamber based on at least a pressure difference between the cavity and the valve outlet.

18. The valve assembly of claim 17, wherein the guide clearance is between about 20 microns and about 50 microns.

19. The valve assembly of claim 14, wherein the base portion further comprises a control portion disposed adjacent the retainer and defining a control clearance between the control portion and the retainer, and wherein the control clearance comprises the clearance that provides fluid communication to the cavity to regulate a position of the valve body between the first end and the second end of the valve chamber based on at least a pressure difference between the valve inlet and the cavity.

20. The valve assembly of claim 19, wherein the control clearance is between about 50 microns and about 150 microns.
